(19) United States
(12) Patent Application Publication
(10) Pub. No.: US 2022/0308004 A1
(43) Pub. Date: Sep. 29, 2022

(54) FLEXIBLE RESISTIVE SINGLE WALLED CARBON NANOTUBE SENSOR FOR POINT OR CARE SCREENING OF DISEASES

(71) Applicant: University of Washington, Seattle, TX (US)

(72) Inventors: Jae-Hyun Chung, Seattle, WA (US); Clement E. Furlong, Seattle, WA (US); Seong-Joong Kahng, Seattle, WA (US); Scott Soelberg, Seattle, WA (US)

(73) Assignee: University of Washington, Seattle, WA (US)

(21) Appl. No.: 17/613,449

(22) PCT Filed: May 28, 2020
(86) PCT No.: PCT/US2020/034953

§ 371 Date: Nov. 22, 2021

Related U.S. Application Data
(60) Provisional application No. 62/853,492, filed on May 28, 2019.

(51) Int. Cl. G01N 27/12; B32B 27/36; B32B 23/04; B32B 27/40

(52) U.S. Cl. CPC G01N 27/127; B32B 27/365; B32B 23/04; B32B 27/40; B32B 2250/24; B32B 2255/20; B32B 2307/538

(57) ABSTRACT

A carbon nanotube-based thin-film resistive sensor is disclosed. The sensor includes carbon nanotube film functionalized with sensing moieties and is configured for use in rapid screening for pathogens in point of care settings.

### CROSS-REFERENCE TO RELATED APPLICATION

This application claims the benefit of U.S. Provisional Application No. 62/853,492 filed May 28, 2019, expressly incorporated hereby in its entirety.

### STATEMENT OF GOVERNMENT LICENSE RIGHTS

This invention was made with Government support under Grant No. W81XWH-17-1-0083 awarded by the Department of Defense. The Government has certain rights in the invention.

### BACKGROUND

Nanomaterials have been investigated for use as a highly sensitive and specific screening tool for pathogen screening. Among nanomaterials, single-walled carbon nanotubes (SWCNTs) are one of the potential candidates for enabling a simple resistive transducer to detect the binding of a target analyte with high sensitivity and specificity. The unique electronic properties render SWCNTs crucial to the development of inexpensive, sensitive biosensing platforms. The high sensitivity of a SWCNT biosensor stems from the small diameter (˜1 nm) comparable to the size of a single biomolecule and the thickness of electrical double layers in physiological buffers. In addition, the low charge carrier density of SWCNTs is comparable to the surface charge density of protein molecules and other antigens, which makes SWCNTs suitable for biomolecular detection. In comparison to optical and fluorescent detection, a resistive sensor operates with a simple measurement at low power in a small form factor.

Resistive SWCNT sensors can detect targets by two distinct mechanisms. One is to change the free carrier density of doped SWCNTs by electrostatic interaction. The other is to change the work function of the metal electrode-SWCNT interface, thus leading to Schottky barrier modulation. For SWCNTs deposited on gold electrodes on a silicon substrate, both mechanisms play roles in modulating the resistance. Viral particles and bacteria can be detected by measuring this resistance change. The lower limit of detection (LLD) of swine influenza virus (H1N1) was 177 TCID₅₀ (50% tissue culture infective dose)/mL. The LLD for Bacillus subtilis was 100 CFU/mL. SWCNTs functionalized with heparin could detect dengue virus as low as 840 TCID₅₀/mL. The LLD was 1 plaque forming unit (PFU)/mL for detecting H1N1. Also, a similar sensing configuration was applied to detect a peanut allergen protein in food extracts with a detection limit of 5 ng/mL. In mRNA detection, the LLD was at attomolar levels, which showed the potential to detect nucleic acid without amplification. Nanotips made of SWCNTs could be used for bacterial detection. The crossbar junctions coated with SWCNTs were fabricated to detect target bacteria in food samples at the detection limit of 100 CFU/mL.

Despite their great potential as a point of care (POC) screening sensor, few resistive SWCNT biosensors have been demonstrated on flexible plastic films. Unlike atomically flat silicon substrates, a rough plastic film made of polymer renders the Schottky modulation unpredictable. The electrodes printed with silver, a popular conductive material on plastic films, significantly increase the contact resistance when SWCNTs are deposited on the oxidized silver surface. The doping effect on SWCNTs by the plastic substrate, functionalization layers, and hydrogen binding in water-based buffer can also generate unreliable resistance changes. In comparison to the oxide layer on a silicon chip, the charge of the SWCNTs is significantly changed by the plastic film. When SWCNTs are conjugated with antibodies in physiological buffer, hydrogen can be bound on SWCNTs to increase the resistance. As soon as the sensor is exposed to air out of buffer, the electrical resistance starts to decrease. The resistance change by target binding can interfere with hydrogen release, which can compromise the sensitivity and reliability of detection.

There remains a need for a low-cost biosensor with low power requirements that can be reliably used in a point-of-care (POC) settings with high sensitivity.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter

In one aspect, the disclosure provides sensor, comprising:
a substrate comprising an upper surface;
a carbon nanotube film bonded to the upper surface of the substrate, comprising carbon nanotubes and a polymeric coating;
one or more electrodes in contact with the carbon nanotube film, wherein the one or more electrodes are formed on top of a portion of the carbon nanotube film; and
one or more sensing moieties configured to recognize one or more target analytes, wherein the one or more sensing moieties are bonded to the carbon nanotube film.

In some embodiments, the substrate is a flexible substrate. In some embodiments, the flexible substrate comprises a polymeric material selected from the group consisting of polyethylene terephthalate (PET), polyethylene, cellulose acetate, polypropylene, polycarbonate, polyurethane, or combinations thereof. In some embodiments, the flexible substrate is a polyethylene terephthalate (PET) film.

In some embodiments, the carbon nanotubes are selected from the group consisting of single walled carbon nanotubes, double walled carbon nanotubes, multi walled carbon nanotubes, or a combination thereof. In some embodiments, the carbon nanotubes are single walled carbon nanotubes. In some embodiments, the carbon nanotubes are treated to desorb pysisorbed hydrogen. In some embodiments, the treatment is selected from heating, incubating under vacuum, incubated in dry environment, or a combination thereof, for a period of time sufficient to desorb the hydrogen pysisorbed on carbon nanotubes.

In some embodiments, the carbon nanotube film is formed by depositing a layer of carbon nanotubes on at least a portion of the upper surface of the flexible substrate and coating the layer of carbon nanotubes with a polymeric material. In some embodiments, the polymeric coating comprises a material comprising one or more functional moieties or groups. In some embodiments, the polymeric coating comprises a polymer selected from the group consisting of polyethyleneimine (PEI), poly-L-lysine (PLL), and combinations thereof. In some embodiments, the functional group is selected from a group consisting of amino, hydrazide, aldehyde, ketone, carboxyl, hydroxyl, thiol, cyano, alkyne, alkene, diene, azide, halogen, pseudohalogen, activated ester, and combinations thereof.

In some embodiments, the one or more sensing moieties are covalently bonded to the carbon nanotube film. In some embodiments, the one or more sensing moieties are non-covalently bonded to the carbon nanotube film. In some embodiments, the one or more sensing moieties are covalently bonded to the one or more functional groups.

In some embodiments, the one or more sensing moieties are configured to capture one or more target analytes selected from the group consisting of a cell, microorganism (such as a virus, fungus, or bacterium), protein, peptide, nucleic acid, lipid, and small molecule.

In some embodiments, the one or more sensing moieties is an aptamer, an antibody, or a binding fragment thereof. In some embodiments, the antibody is a polyclonal or a monoclonal antibody. In some embodiments, the one or more sensing moieties is an antibody against a viral surface antigen, a fungal surface antigen, a bacterial surface antigen, a membrane protein, or an immunoglobulin. In some embodiments, the one or more sensing moieties is a polynucleotide. In some embodiments, the polynucleotide is complementary to at least a portion of a viral nucleic acid, a fungal nucleic acid, or a bacterial nucleic acid.

In some embodiments, the sensor is configured to detect the presence of one or more microorganisms in a sample. In some embodiments, the one or more microorganisms is a virus selected from the group consisting of HIV, HCV, HBV, HPV, Ebola virus, Avian Flu virus, West Nile virus, Coronavirus, flavivirus, and combinations thereof. In some embodiments, the one or more microorganisms is a virus selected from the group consisting SARS-CoV-2, MERS-CoV, SARS-CoV, and combinations thereof. In some embodiments, the one or more microorganisms is a bacterium selected from the group consisting of a Mycobacterium, Streptococcus, Campylobacter, Clostridium, Escherichia coli, Staphylococcus aureus, MRSA, Salmonella, Listeria, Pseudomonas aeruginosa, Chlamydia trachomatis, Yersinia pestis, and combinations thereof. In some embodiments, the antibody is an antibody against a Mycobacterium surface antigen. In some embodiments, the antibody is an antibody against MPT64 surface antigen of Mycobacterium tuberculosis (MTB). In some embodiments, the antibody is an antibody against a surface protein of a virus selected from the group consisting of SARS-CoV-2, MERS-CoV, SARS-CoV, and combinations thereof.

In some embodiments, the one or more electrodes are fabricated by stamping, screen printing, ink jet printing, or physical vapor deposition. In some embodiments, the one or more electrodes comprise a material selected from the group consisting of silver, gold, platinum, palladium, carbon, transparent conductive oxide, and combinations thereof. In some embodiments, the one or more electrodes are silver electrodes. In some embodiments, the one or more electrodes have interdigitated, rectangular, or circular shapes.

In some embodiments, the sensor is configured to detect the target analyte by an electrostatic gating effect and not a Schottky effect.

In some embodiments, the sensor is configured to detect the resistance change at the interface of the carbon nanotubes and one or more metal electrodes.

In some embodiments, the sensor is configured to measure the resistance or electric current generated upon binding of the target analyte to the one or more sensing moieties. In some embodiments, the resistance change of carbon nanotubes is amplified by the means selected from a group consisting of charged molecules, electrochemical amplification, and magnetic force.

In some embodiments, the sensor is flexible or bendable. In some embodiments, the sensor is configured to monitor the presence of a target analyte in real time. In some embodiments, the monitoring of the presence of a target analyte is performed in vivo, ex-vivo, or in vitro. In some embodiments, the sensor is configured to be incorporated into a container, a wearable gear, a mask, glasses, an item of clothing, or an item of personal protective equipment (PPE).

In another aspect, provided herein is a method of forming a sensor, comprising:
depositing carbon nanotube powder on a surface of a substrate to form a substrate comprising a layer of carbon nanotubes bonded to the surface of the substrate;
coating the layer of carbon nanotubes with a polymeric coating to form carbon nanotube film;
forming one or more electrodes in contact with the carbon nanotube film on a portion of the carbon nanotube film; and
contacting the portion of the carbon nanotube film not covered by the one or more electrodes with one or more sensing moieties configured to recognize one or more target analytes with the carbon nanotube film thereby binding the one or more sensing moieties to the carbon nanotube film.

In some embodiments, the carbon nanotubes are selected from the group consisting of single walled carbon nanotubes, double walled carbon nanotubes, multi walled carbon nanotubes, or a combination thereof. In some embodiments, the carbon nanotubes are single walled carbon nanotubes. In some embodiments, the carbon nanotubes are treated to desorb hydrogen pysisorbed on carbon nanotubes.

In some embodiments, the contacting of the one or more sensing moieties results in covalent bonding of the one or more sensing moieties to the carbon nanotube film. In some embodiments, the contacting of the one or more sensing moieties results in non-covalent bonding of the one or more sensing moieties to the carbon nanotube film.

In some embodiments, the one or more sensing moieties are configured to capture one or more target analytes selected from the group consisting of a cell, microorganism, protein, peptide, nucleic acid, lipid, and small molecule.

In some embodiments, the sensor is configured to detect one or more bacterial surface antigens, fungal surface antigens, or viral surface antigens, membrane proteins, or immunoglobulins.

In some embodiments, the forming of the one or more electrodes is done by stamping, screen printing, ink jet printing, or physical metal vapor deposition. In some embodiments, the one or more electrodes comprise material selected from silver, gold, platinum, palladium, carbon, transparent conductive oxide, and combinations thereof. In some embodiments, the one or more electrodes are silver electrodes.

In some embodiments, the polymeric coating comprises polyethyleneimine (PEI). In some embodiments, the polymeric coating is cured at a temperature of about 30° C. to about 40° C. for about 1 hour to about 3 hours after application to carbon nanotubes. In some embodiments, the polymeric coating comprises polyethyleneimine (PEI). In some embodiments, the polymeric coating is cured at a temperature of about 30° C. to about 40° C. for about 1 hour to about 3 hours prior to forming the one or more electrodes.

In another aspect, provided herein is a sensor formed by the method of the disclosure.

In another aspect, provided herein is a method of detecting one or more target analytes in a sample, comprising contacting a sample with a sensor disclosed herein.

In some embodiments, the method comprises measuring resistance change upon binding of the one or more target analytes to the one or more sensing moieties. In some embodiments, the sample is saliva, sputum, tongue swab, nasal swab, urine, blood, serum, or plasma. In some embodiments, the one or more target analytes in the sample is labeled with a secondary label prior to contacting the sample with the sensor. In some embodiments, the secondary label is a magnetic bead.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A depicts an exemplary SWCNT-based sensor on a flexible PET film. FIG. 1B is a cross-section of a resistive SWCNT immunosensor for direct target capture. FIG. 1C is a cross-section of a resistive SWCNT immunosensor in combination with magnetic enrichment. FIG. 1D shows fabrication process of a SWCNT-immunosensor FIG. 1E Optical microscope image of a SWCNT immunosensor. The dark region is silver electrodes. FIG. 1F is a zoomed-out image of FIG. 1E. FIG. 1G is a SEM image of an exemplary sensor; the bright area is silver electrodes, and the dark area is SWCNTs. FIG. 1H is an exploded view of FIG. 1G; a bundled SWCNT film.

FIGS. 2A-2B depict exemplary sample preparation protocol and resistive detection procedure for tongue swab samples (2A) and sputum samples (2B).

FIG. 3A shows normalized resistance change before and after immobilization of various concentration antibodies on exemplary SWCNT sensors (N=4). FIG. 3B shows normalized resistance change of an exemplary SWCNT immunosensor at 25° C. and 35° C. after the incubation in antibody solution and PBS water. The sensor is coated with PEI before the incubation. FIG. 3C shows normalized resistance change of an exemplary SWCNT sensor for control and MTB (10⁶ CFU/mL) in PBS (N=4). The sensor is tested after 5, 20, 40, and 120 min-curing at 25° C. FIG. 3D shows normalized resistance change of an exemplary SWCNT sensor for control and MTB (10⁶ CFU/mL) in PBS (N=4). The sensor is tested after 5, 20, 40, and 120 min-curing at 35° C.

FIG. 4A shows sensitivity test for MTB in PBS (N=4). FIG. 4B shows sensitivity test for MPT64 in PBS (N=4). FIG. 4C shows specificity test results for MTB (10² CFU/mL), S. Epi (10³ CFU/mL), M. Avium (10³ CFU/mL), and M. BCG (10³ CFU/mL) (N=4).

FIGS. 5A-5B show detection limit tests for MTB and MPT64 in tongue swab samples: MTB spiked in tongue swab samples (N=4) (5A) and MPT64 antigen spiked in tongue swab samples (N=4) (5B).

FIGS. 6A-6B show detection limit tests for MTB and MPT64 in spiked in sputum samples. The targets are enriched with magnetic beads then detected with the sensors: MTB spiked in sputum samples (N=4) (6A) and MPT64 spiked in sputum samples (N=4) (6B).

FIGS. 7A and 7B are SEM images of MTB cells (10⁶ CFU/mL) in PBS. The image was captured on an exemplary SWCNT sensor surface. FIGS. 7C and 7D are SEM images of MTB cells (10⁶ CFU/mL) captured with magnetic beads in PBS. The image was captured on an exemplary SWCNT sensor surface.

FIG. 8A shows optical density showing the binding of MPT64 antibodies (28 μg/mL) to MTB (10⁶ CFU/mL) and BCG (10⁶ CFU/mL). FIG. 8B shows optical density showing the binding of MPT64-antibodies to MPT64 in comparison to control.

FIG. 9 shows normalized resistance change of an exemplary SWCNT sensor at 25° C. and 35° C. after immersion in DI water for 24 hours. The SWCNTs without and with a PEI layer are tested without antibodies.

FIG. 10 shows resistances of 0.1% PEI-coated SWCNTs and antibody-coated SWCNTs. The resistance is measured after 2 hours at 35° C. (N=4).

FIG. 11 is an AFM image of a PET film used in the experiment. The roughness is smaller than 80 nm.

FIG. 12A depicts bending test using a 3 mm silicone bar; FIG. 12B shows resistance change for the 1^{st} bending and the 1^{st} recovery (N=6).

### DETAILED DESCRIPTION

The disclosure provides a resistive sensor for inexpensive and simple pathogen screening or disease diagnosis, methods of sensor manufacture, and methods of sensor use. The sensors and methods disclosed herein are useful for rapid, low-cost point-of-care diagnosis of bacterial, fungal, or viral infections.

In one aspect, provided herein is a sensor, comprising:
a substrate, such as a flexible substrate, comprising an upper surface;
a carbon nanotube film bonded to the upper surface of the substrate, comprising carbon nanotubes and a polymeric coating;
one or more electrodes in contact with the carbon nanotube film, wherein the one or more electrodes are formed on top of a portion of the carbon nanotube film; and
one or more sensing moieties configured to recognize one or more target analytes, wherein the one or more sensing moieties are bonded to the carbon nanotube film.

In some embodiments, the substrate is flexible. In some embodiments, the substrate is rigid or non-bendable. In some embodiments, the substrate is a flexible polymeric substrate such as a polymeric film.

Any suitable polymetric substrate can be used in the sensors of the disclosure. In some embodiments, the substrate comprises an ethylenic backbone polymer or a carbohydrate polymer. In some embodiments, the polymeric substrate comprises a material selected from the group consisting of polyethylene terephthalate (PET), polyethylene, cellulose acetate, polypropylene, polycarbonate, polyurethane, or combinations thereof. In some embodiments, the polymeric substrate is a polyethylene terephthalate (PET) film. In some embodiments, the polymeric substrate comprises a single polymer layer. In some embodiments, the polymeric substrate can comprise more than one layer. The substrates typically have a thickness of about 5 μm to about 1 mm, about 10 μm to about 500 μm, about 100 μm to about 1 mm, about 100 μm to about 500 μm, or about 10 μm to about 1 mm In some embodiments, the polymeric substrate, such as PET film substrate, has a rough surface. For example, in some embodiments, as measured by an atomic force microscopy, the roughness of the surface can range from about 15 nm to about 80 nm (as represented by bumps on the substrate's surface). In some embodiments, the rough surface of the polymeric support, e.g., a PET film, contributes to the high contact resistance of the sensor. In some embodiments, the polymeric support is flexible and can be easily cut to a desired shape.

Any suitable carbon nanotubes can be used in the sensors of the disclosure. In some embodiments, the carbon nanotubes can be single walled carbon nanotubes, double walled carbon nanotubes, multi walled carbon nanotubes, or a combination thereof. In some embodiments, the carbon nanotubes are single walled carbon nanotubes (SWCNT). In some embodiments, the carbon nanotubes are treated to desorb pysisorbed hydrogen molecules prior to applying to the substrate. Suitable methods of treatment to desorb pysisorbed hydrogen molecules include heating, incubating under vacuum, incubating in dry environment, or a combination thereof, for a period of time sufficient to desorb hydrogen pysisorbed on carbon nanotubes, such as SWCNT.

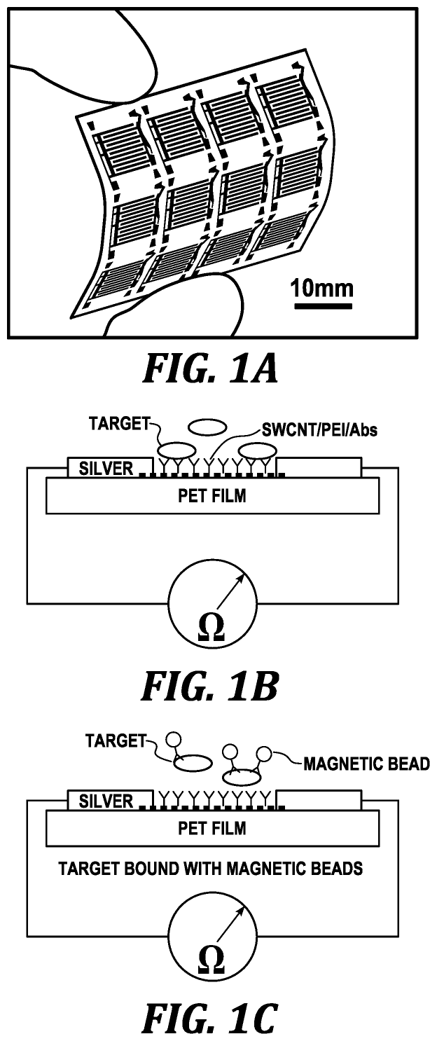

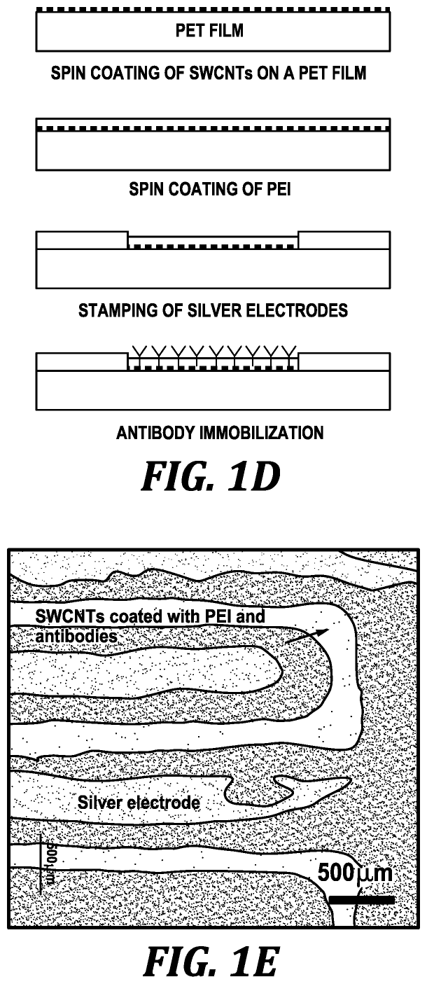

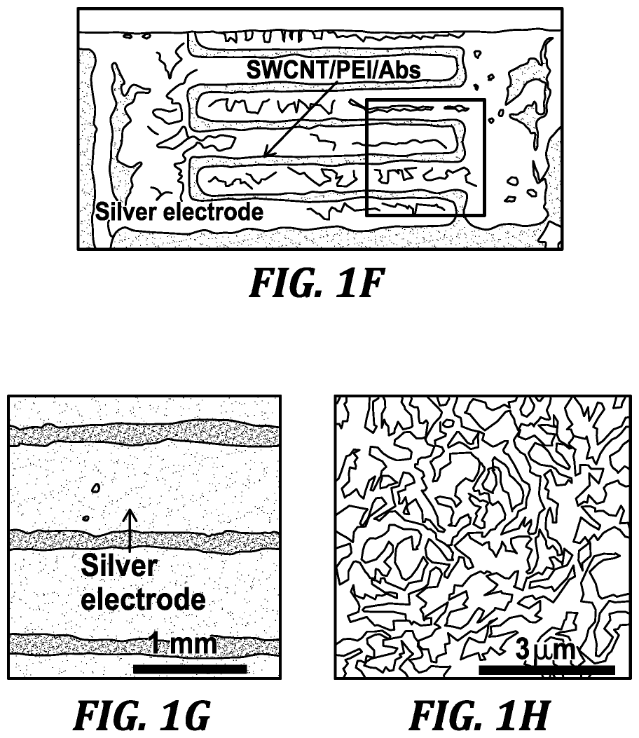

The carbon nanotube film of the sensors of the disclosure can be formed by any suitable method. For example, in some embodiments, a layer of carbon nanotubes can be deposited on at least a portion of the upper surface of the substrate, such as a flexible polymeric film, followed by coating the layer of carbon nanotubes with a polymeric coating. For example, in one exemplary embodiment, as illustrated in FIGS. 1A-1D, SWCNTs can be dispersed in an aqueous solution comprising a suitable detergent at a suitable concentration and then spin-coated onto a polymeric substrate, such as a PET film. The resulting SWCNT can be further cured, e.g., by incubation at an elevated temperature, and a suitable polymeric coating can be then applied to the SWCNTs' surface. In some embodiments, the carbon nanotubes can be coated with a polymeric coating prior to the deposition onto the surface of the polymeric substrate. In some embodiments, the carbon nanotubes are not coated.

Typically, the polymeric coating used in the sensors of the disclosure comprises a polymeric material comprising one or more functional groups or moieties. The functional group can be used to link one or more sensing moieties to the carbon nanotube film by a covalent bond or non-covalent interaction.

In some embodiments, the functional group is a positively charged group or a positively chargeable group, such as amino or guanidinium group. In some embodiments, the functional group is a negatively charged group or a negatively chargeable group, such as sulfonic acid, carboxylic acid, phosphonic acid, or phosphate. Non-limiting examples of suitable polymeric coatings include polymers comprising positively charged or positively chargeable groups, such as polyethyleneimine (PEI), poly-L-lysine (PLL), and combinations thereof.

In some embodiments, the functional moiety or group is a group that can be used to covalently link a sensing moiety to the polymeric coating. Non-limiting examples of suitable functional groups include amino, carboxyl, hydroxyl, thiol, cyano, alkyne, alkene, diene, tetrazine, hydrazide, aldehyde, ketone, azide, halogen (such as chloro, iodo, bromo), pseudohalogens, activated esters (such as NHS and PFP esters), and combinations thereof. In some embodiments, the one or more sensing moieties are covalently bonded to the one or more functional groups. Covalent bonding of the one or more sensing moieties can be achieved in any suitable manner, for example, via formation of amide, ester, disulfide, etc. In some embodiments, the bonding can be achieved through a cycloaddition reaction, for example, using reactions typically referred to as “click” chemistries.

In some embodiments, the polymeric coating comprises an affinity ligand (for example, biotin) that can selectively bind to a counterpart ligand (for example, avidin) attached to a sensing moiety. Any suitable affinity pairs can be used to link one or more sensing moieties to the carbon nanotube film or carbon nanotubes.

In some embodiments, the one or more sensing moieties are non-covalently bonded to the carbon nanotube film. Non-covalent bonding includes but is not limited to electrostatic interactions, ionic bonding, hydrophobic interactions, hydrogen bonding, complexation, and affinity complex formation (for example, formation of an avidin-biotin complex or boronic acid-s alicylhydroxamic acid complex).

The one or more sensing moieties of the sensors of the disclosure are moieties configured to selectively capture or bind to one or more target analytes. In some embodiments, the one or more target analytes are selected from the group consisting of cells, microorganisms (such as viruses, bacteria, and fungi), proteins, peptides, lipids, nucleic acids, and small molecules.

In some embodiments, the sensor of the disclosure is an immunosensor, wherein the one or more sensing moieties is an aptamer, an antibody, or a binding fragment thereof. Suitable aptamers, antibodies, or binding fragments thereof include aptamers, antibodies, or binding fragments thereof against a surface antigen (such as viral, bacterial, or fungal surface antigen), a membrane protein, an immunoglobulin, or another protein. In some embodiments, the one or more sensing moieties is an aptamer, an antibody, or a binding fragment thereof against a small molecule, a carbohydrate, or a lipid. In some embodiments, the immunosensors are configured to detect the presence of an antigen in a sample. In some embodiments, the immunosensors are configured to detect the presence of an antibody, such as IgG or IgM, generated in response to exposure to an antigen.

In some embodiments, the sensor is configured to detect a nucleic acid, such as mRNA, microRNA, genomic DNA, viral RNA, cell-free (CF) nucleic acid, rRNA, cDNA, and combinations thereof. In some embodiments, the one or more sensing moieties is a polynucleotide, e.g., a capture probe. As used herein, the term “polynucleotide” generally refers to a polymer that comprises about 5 to about 300 nucleotide monomer units. In addition to nucleotide monomer units, a polynucleotide can incorporate one or more additional moieties, such as intercalators, minor groove binders, detectable labels, and one or more reactive groups. The nucleotide monomer units comprise natural (e.g., deoxyribose or ribose) or non-natural (e.g., morpholino) backbone moieties substituted with heterocyclic bases. The backbone moieties are linked by conventional or natural (e.g., phosphate) backbone moieties or non-conventional (e.g., amide) moieties. In some embodiments, a polynucleotide can comprise one or more modified bases and/or backbone moieties. In some embodiments, a polynucleotide can comprise only non-natural nucleotide monomer units. As used herein, the term “base” means a nitrogen-containing heterocyclic moiety capable of forming hydrogen bonds (e.g., Watson-Crick or Hoogsteen type hydrogen bonds) with a complementary nucleotide base or nucleotide base analog. Typical bases include the naturally occurring bases adenine, cytosine, guanine, thymine, and uracil. Bases also include analogs of naturally occurring bases such as deazaadenine, 7-deaza-8-azaadenine, 7-deazaguanine, 7-deaza-8-azaguanine, inosine, nebularine, nitropyrrole, nitroindole, 2-amino-purine, 2,6-diamino-purine, hypoxanthine, 5-methylcytosine, isocytosine, pseudoisocytosine, 5-bromouracil, 5-propynyluracil, 6-aminopurine, 2-chloro-6-aminopurine, xanthine, hypoxanthine, etc. Non-limiting examples of suitable polynucleotides include DNA, RNA, locked nucleic acid (LNA), peptide nucleic acid (PNA), morpholino nucleic acids, and hybrids thereof.

In some embodiments, the one or more sensing moieties is a polynucleotide that is complementary to at least a portion of the target nucleic acid, such as a viral nucleic acid or a bacterial nucleic acid. As used herein, the term “complementary” refers to the ability of polynucleotide sequences to hybridize to and from base pairs with one another. The percentage of “complementarity” of a probe sequence to a target sequence is the percentage “identity” of the probe sequence to the sequence of the target or to the complement of the sequence of the target. In determining the degree of “complementarity” between a probe and a target sequence, the degree of “complementarity” is expressed as the percentage identity between the sequence of the probe and the sequence of the target sequence or the complement of the sequence of the target sequence that best aligns therewith. The terms “hybridize” and “hybridization” are used herein with reference to “specific hybridization” which is the binding, duplexing, or annealing of a nucleic acid molecule preferentially to a particular nucleotide sequence.

In some embodiments, the sensors of the disclosure are configured to detect the presence of one or more microorganisms, such as fungi, viruses, or bacteria, or combinations thereof, in a sample. In some embodiments, the sensors of the disclosure are configured to detect one or more viruses, for example, viruses selected from the group consisting of HIV, HCV, HBV, HPV, Avian Flu, West Nile virus, Ebola virus, Coronavirus, flavivirus, and combinations thereof. In some embodiments, the one or more viruses are SARS-CoV-2, MERS-CoV, SARS-CoV, and combinations thereof. In some embodiments, the sensors of the disclosure are configured to detect one or more bacteria. In some embodiments, the one or more bacteria is a Gram-positive or a Gram-negative bacterium. In some embodiments, the one or more bacteria is selected from the group consisting of a Mycobacterium, Escherichia coli, Staphylococcus aureus, MRSA, Salmonella, Listeria, Pseudomonas aeruginosa, Chlamydia trachomatis, Yersinia pestis, and combinations thereof.

In some embodiments, the sensor is an immunosensor configured to detect a Mycobacterium tuberculosis (MTB) bacterium, wherein the sensing moiety is an aptamer, an antibody, or a binding fragment thereof against a Mycobacterium surface antigen. In some embodiments, the sensing moiety is an antibody against MPT64 surface antigen of Mycobacterium tuberculosis (MTB).

In some embodiments, the sensor is configured to detect a coronavirus. In some embodiments, the sensor is an immunosensor configured to detect a coronavirus. In some embodiments, the sensor comprises an aptamer, an antibody, or a binding fragment thereof against an antigen (e.g., an epitope) of a virus selected from the group consisting of SARS-CoV-2, MERS-CoV, SARS-CoV, and combinations thereof. Suitable antigens include spike proteins, spike protein mimetics, and their fragments.

The sensors of the disclosure comprise one or more electrodes, e.g., metal electrodes. In some embodiments, the one or more electrodes are formed on the top of the carbon nanotube film. The one or more electrodes can be fabricated in any suitable manner, for example, by stamping, screen printing, ink jet printing, or physical vapor deposition onto the carbon nanotube film. Any suitable material can be used to fabricate the one or more electrodes, for example, materials comprising silver, gold, platinum, palladium, carbon, and combinations thereof. In some embodiments, the one or more electrodes are silver electrodes. In an exemplary embodiment, a stamp coated with silver ink can be used to print silver electrodes on a PEI-coated SWCNT film followed by heating to cure the silver ink.

The one or more electrodes of the sensors can have any suitable shape. In some embodiments, wherein the one or more metal electrodes can have interdigitated, rectangular, or circular shapes.

The sensors of the disclosure are configured to detect the target analyte by an electrostatic gating effect and not a Schottky effect. In some embodiments, the sensor is configured to detect the resistance change at the interface of the carbon nanotubes and the one or more metal electrodes. In some embodiments, the sensor is configured to measure the resistance or electric current generated upon binding of the target analyte to the one or more sensing moieties. In some embodiments, the resistance change of carbon nanotubes is amplified by the means selected from a group consisting of charged molecules, electrochemical amplification, and magnetic force.

The sensors of the disclosure can be flexible or bendable. In some embodiments, the sensor can be attached to an object or bent to fit a testing condition. The resistance change upon bending of the sensor is negligible compared to the resistance change upon binding of the target analyte. In some embodiments, the resistance change upon bending of the sensor is less than about 5%, less than about 3%, less than about 1%, less than about 0.5%, less than about 0.33%, or less than about 0.25%. In some embodiments, the resistance change upon bending is less than about 5%, less than about 4%, less than about 3%, less than about 2%, or less than about 1% of the resistance change generated upon binding of the target analyte. Thus, in some embodiments, the sensor can be bent during target binding and operation. Such flexible nature is beneficial for the sensor application in the platforms requiring a small form factor and low cost.

In some embodiments, the sensor is configured to be incorporated into a container, a wearable gear, a mask, glasses, an item of clothing, or an item of personal protective equipment (PPE).

The sensors of the disclosure have low power requirements, for example, about about 1 W or less, about 500 mW or less, about 100 mW or less, about 50 mW or less, about 10 mW or less, or about 5 mW or less. For example, in some embodiments, an exemplary sensor has a power requirement of 1 mW, including the operation of a microprocessor (e.g., Atmega328).

The sensors of the disclosure can be configured to monitor the presence of a target analyte in real time. The monitoring of the presence of a target analyte can be performed in vivo, ex-vivo, or in vitro. In some embodiments, the sensor can be used to monitor a person's exposure to a specific pathogen, such as a virus or bacterium, in real time.

In another aspect, provided herein is a method of forming a sensor, comprising:
on a flexible substrate comprising a carbon nanotube film, forming one or more electrodes in contact with the carbon nanotube film and covering a portion of the carbon nanotube film; and
contacting the portion of the carbon nanotube film not covered by the one or more electrodes with one or more sensing moieties configured to recognize one or more target analytes with the carbon nanotube film thereby binding the one or more sensing moieties to the carbon nanotube film.

In some embodiments, the method comprises depositing carbon nanotubes on a surface of a substrate, such as a flexible substrate, to form a substrate comprising a layer of carbon nanotubes bonded to the surface of the substrate followed by coating the layer of carbon nanotubes with a polymeric coating to form a carbon nanotube film on the surface of the flexible substrate. In some embodiments, the method comprises forming a carbon nanotube film by depositing carbon nanotubes pre-coated with a polymeric coating.

In some embodiments, the carbon nanotubes are selected from the group consisting of single walled carbon nanotubes, double walled carbon nanotubes, multi walled carbon nanotubes, or a combination thereof. In some embodiments, the carbon nanotubes are single walled carbon nanotubes (SWCNTs), such as those described above.

In some embodiments, the carbon nanotubes are further coated with a polymeric coating. In some embodiments, the polymeric coating comprises a polymer comprising one or more functional moieties or groups. Suitable polymeric coatings include those described above. In some embodiments, the polymeric coating comprises a polymer selected from the group consisting of polyethyleneimine (PEI), poly-L-lysine (PLL), and combinations thereof. In an exemplary embodiment, the polymeric coating comprises polyethyleneimine (PEI). In some embodiments, the polymeric coating is cured at a temperature of about 30° C. to about 40° C. for about 1 hour to about 3 hours prior to forming the one or more electrodes. In some embodiments, the polymer is polyethyleneimine (PEI) cured at 35° C. for about 2 hours, for example, to control the doping level of carbon nanotubes.

In some embodiments, the forming of the one or more electrodes is done by stamping, screen printing, ink jet printing, or physical metal vapor deposition. In some embodiments, the one or more metal electrodes comprise material selected from silver, gold, platinum, carbon, palladium, transparent conductive oxide, and combinations thereof. In some embodiments, the one or more electrodes are silver electrodes. The electrodes can have any suitable shape. In some embodiments, the sensor comprises one pair of interdigitated electrodes. In some embodiments, the electrodes connected with functionalized SWCNTs have a gap of size of from about 100 μm to about 500 μm.

In some embodiments, multiple sensors can be fabricated on a single sheet of flexible support, for instance, in one exemplary embodiment, 24 sensors can be fabricated on a 40×40 mm² sheet of PET film. The sensors can be separated after forming, for example, by by cutting.

In some embodiments, the one or more sensing moieties are bound to the carbon nanotube film by a covalent bond. In some embodiments, the one or more sensing moieties are bound to the carbon nanotube film by a non-covalent interaction. Binding of the one or more sensing moieties to the carbon nanotube film can be achieved in any suitable manner, such as using those methods described above.

In some embodiments, the one or more sensing moieties are configured to capture one or more target analytes selected from the group consisting of cells, microorganisms (e.g., viruses, bacteria, fungi), proteins, peptides, nucleic acids, lipids, small molecules. Examples of target analytes are described above. In some embodiments, the one or more sensing moieties is an aptamer, an antibody, or a binding fragment thereof. In some embodiments, the one or more sensing moieties is a polynucleotide. Suitable examples of sensing moieties that can be used in the sensors of the disclosure include those described above. In some embodiments, the sensor prepared as described above is configured to detect one or more bacterial, fungal, or viral antigens or epitopes, for example, a viral surface protein or a fragment thereof.

In another aspect, provided herein is a sensor formed by the method of the disclosure.

In another aspect, provided herein is a point of care instrument or device comprising one or more sensors of the disclosure.

In another aspect, the disclosure provides a method of detecting one or more target analytes in a sample, comprising contacting a sample with a sensor of the disclosure.

In some embodiments, the method comprises measuring resistance change of the sensor upon binding of the one or more target analytes to the one or more sensing moieties. In some embodiments, the method comprises comparing the resistance of the sensor contacted with the sample to the resistance of a control sensor. The control sensor can be fabricated in parallel with the detecting sensor and used to confirm the effective binding of sensing moieties such as probe antibodies and to compensate the change of the sensor surface.

Any suitable samples can be analyzed using the methods of the disclosure. In some embodiments, the samples are biological samples, such as, but not limited to, urine, blood, serum, plasma, saliva, perspiration, feces, cheek swabs, nasal swabs, cerebrospinal fluid, cell lysate samples, and the like. The sample can be a biological sample or can be extracted from a biological sample derived from humans, animals, plants, fungi, yeast, bacteria, tissue cultures, viral cultures, or combinations thereof using conventional methods for the successful extraction of DNA, RNA, proteins, and peptides. In some instances, the samples of interest are water, food, or soil samples. In some embodiments, the sample is saliva, sputum, nasal swab, or tongue swab. In some embodiments, the sample is a bodily fluid. In some embodiments, the sample is serum, plasma, or blood.

In some embodiments, the one or more target analytes in the sample can be labeled with a secondary label prior to contacting the sample with the sensor. In some embodiments, the secondary label is a moiety that increases the signal produced by the sensor upon binding of such a labeled analyte as compared to binding of the same amounts of unlabeled analyte. In some embodiments, the secondary label is a magnetic bead. Any suitable methods for labeling the target analyte can be used. For example, a target protein in a sample can be labeled by incubating the sample with a magnetic bead-labeled antibody or a binding fragment thereof. Likewise, a target nucleic acid in a sample can be hybridized with a polynucleotide comprising a magnetic bead, wherein the polynucleotide comprising a magnetic bead is complementary to a portion of the target nucleic acid sequence different from the portion of the sequence complementary to the capture probe of the sensor.

The methods of the disclosure can be used for rapid detection of infectious agents, such as bacteria or viruses, in a point of care setting. In some embodiments, the methods can be used to test food samples for the presence of one or more pathogens, such as E. coli or Listeria. In some embodiments, the methods can be used for environmental monitoring or public health surveillance. In some embodiments, the sensors can be used to monitor a person's exposure to a particular pathogen. In some embodiments, the methods can be used to diagnose a condition or a disease, such as a viral, fungal, or bacterial disease. In some embodiments, the methods can be used to diagnose COVID-19 infection. In some embodiments, the methods can be used to diagnose a tuberculosis infection. In some embodiments, the sensors can be used to confirm the presence of an immunoglobulin, such as an IgG or IgM, produced in response to exposure to a particular antigen, such as a spike protein of a coronavirus.

While each of the elements of the present invention is described herein as containing multiple embodiments, it should be understood that, unless indicated otherwise, each of the embodiments of a given element of the present invention is capable of being used with each of the embodiments of the other elements of the present invention and each such use is intended to form a distinct embodiment of the present invention.

As used herein, “about” means within a statistically meaningful range of a value, for example, a stated concentration, length, purity, time, or temperature. Such a range can be typically within 20%, more typically within 10%, and more typically still within 5% of a given value or range. The allowable variation encompassed by “about” will depend upon the particular system or method used to determine the value and can be readily appreciated by those of skill in the art.

The referenced patents, patent applications, and scientific literature referred to herein are hereby incorporated by reference in their entirety as if each individual publication, patent or patent application were specifically and individually indicated to be incorporated by reference. Any conflict between any reference cited herein and the specific teachings of this specification shall be resolved in favor of the latter. Likewise, any conflict between an art-understood definition of a word or phrase and a definition of the word or phrase as specifically taught in this specification shall be resolved in favor of the latter.

As can be appreciated from the disclosure above, the present invention has a wide variety of applications. The invention is further illustrated by the following examples, which are only illustrative and are not intended to limit the definition and scope of the invention in any way.

### EXAMPLES

The following examples illustrate preparation of an exemplary sensor of the disclosure. An exemplary resistive SWCNT biosensor was fabricated on a polyethylene terephthalate (PET) film for low-cost TB screening. Silver electrodes were stamped on SWCNTs to reduce the contact resistance. The sensor response of SWCNTs coupled with silver electrodes was studied in conjunction with the binding of antibodies and target molecules. The sensitivity and specificity were characterized for MTB and surface antigen (MPT64) in phosphate buffered saline (PBS). The sensor was also characterized using two types of samples, tongue swabs and sputa. Oral swab samples were tested due to their recent discovery as a convenient biosample source for TB diagnosis. The targets in sputum samples were detected in combination with magnetic enrichment because of the sample complexity and the high ionic concentrations of reagents used in sputum liquefaction. The resistance change was measured upon the binding of either MTB or MPT64 spiked in two kinds of biosamples, tongue swab- and sputum samples.

The sensor is composed of single-walled carbon nanotubes (SWCNTs) functionalized with polyclonal antibodies raised against the MPT64 surface antigen from Mycobacterium tuberculosis (MTB). The target analyte of either MTB or MPT64 is spiked in tongue swab and sputum samples. Unlike on atomically flat silicon chips, the major challenge for the development of a resistive SWCNT sensor on a plastic film is to achieve uniform performance on a rough polymer film. The SWCNT sensor on a polyethylene terephthalate (PET) is characterized for immuno-resistive detection of MTB and MPT64. Under optimized conditions, targets were directly detected from tongue swab samples. Target analytes spiked into the more complex matrix of human sputa were enriched with a magnetic bead protocol followed by resistive detection. The sensitivity and specificity were determined along with the lower limit of detection in both samples. This highly sensitive film sensor can facilitate inexpensive and rapid TB screening with the added benefits of a small form factor, simple operation, low power requirement, and low cost.

Tuberculosis, an infection caused by Mycobacterium tuberculosis (MTB), is one of the most serious infectious diseases worldwide. Although the incidence is gradually declining, developing countries have a significantly higher mortality rate than developed countries. In Asian and African countries, MTB infection occurs in 80% of the population. Currently, for the initial TB screening, three sputum samples are collected from a patient in the early morning. This sample collection procedure is then repeated several times for initial diagnosis. Microbial culture from sputum is the gold standard diagnostic method but requires laboratory infrastructure with trained personnel and takes a few weeks for results.

For rapid TB screening, the collected samples are diagnosed with various methods, such as, the Ziehl-Neelsen (ZN) method for microscopic detection, immunoassays for antigen detection, or polymerase chain reaction (PCR) for DNA or RNA detection. The ZN smear method is labor-intensive and not sufficiently sensitive for TB diagnosis Immunoassays, for example, the enzyme-linked immunosorbent assay (ELISA) for antigen detection, are rapid screening tools but with limited sensitivity and specificity. Among the screening approaches, PCR-based methods have shown clinical sensitivity and specificity greater than 95% with a 2-hour detection time. However, trained personnel in a well-equipped laboratory infrastructure are required with a stable electric power supply and a relatively high running cost. Consequently, the main challenge for TB diagnosis is the lack of rapid, simple, inexpensive, and accurate screening tools, especially for point-of-care (POC) diagnosis in resource-limited settings.

Sensor Configuration and Fabrication

The sensors were fabricated on polyethylene terephthalate (PET) films (FIG. 1A). Target cells and antigen were detected using a SWCNT sensor functionalized with polyethyleneimine (PEI) and antibodies. FIG. 1B shows the direct detection of targets on the sensor surface, while FIG. 1C shows the detection of targets enriched with magnetic nanoparticles. Interdigitated silver electrodes were stamped for resistive detection. When targets were bound on the sensor surface, the resistance decreased due to the electrostatic interaction.

For fabrication (FIG. 1D), SWCNTs were dispersed in 1%-SDS at a concentration of 5 mg/mL using an ultrasonic bath at room temperature for 3 hours. The SWCNTs were spin-coated onto a PET film at 6,000 rpm for 20 seconds. The SWCNT film was cured at 100° C. on a hot plate for 10 minutes. PEI [0.1% in deionized (DI) water] was coated on the SWCNT surface. Subsequently, the PEI-coated SWCNT film was cured at 100° C. on a hot plate for 10 minutes. For silver electrode patterning, a Delrin® mold was machined by using an end mill. The stamp was made of polydimethylsiloxane (PDMS) cured in a mold at room temperature for 3 days. The PDMS stamp coated with silver ink (EMS CI-1001) was used to print silver electrodes on the PEI-coated SWCNT sensors. The sensors were heated at 80° C. on a hot plate for 1 hour to cure silver ink.

A polyclonal IgY antibody (1.8 mg/mL in PBS) raised against MPT64 protein was immobilized on the SWCNT surface in PBS for 24 hours in a refrigerator (4° C.). Subsequently, the sensors were cured on a hot plate of 35° C. for 2 hours. Each sensor was cut with scissors by half to generate 2 sensors (FIG. 1E and 1F). A total of 24 sensors were fabricated on a 40×40 mm² PET film. FIG. 1F shows a sensor image composed of one pair of interdigitated electrodes. The silver electrodes having the gap size of 200˜300 μm are connected with functionalized SWCNTs (FIG. 1G and 1H).

In the sensor configuration, silver electrodes were stamped on SWCNTs in order to minimize the exposure of the interfacial area between SWCNTs and silver electrodes. In the configuration, the oxidation of silver electrode surface should not affect the resistive change for target detection, which offered a uniform contact resistance and isolated the Schottky effect in the sensing mechanism. The electrostatic gating effect was the only mechanism that detected the target analytes.

Antibody Preparation

Polyclonal IgY antibodies (pAb) were raised against purified MPT64 protein by Ayes Labs (Davis, Calif., USA). Complete Freund's adjuvant was used; thus, antibodies were reactive to MTB as well as MPT64. The antibodies were raised in two hens and evaluated by enzyme-linked immunosorbent assay (ELISA) to determine the binding to target MPT64 protein, and by filter plate enzyme immunoassay (EIA) to determine the reactivity to target cells.

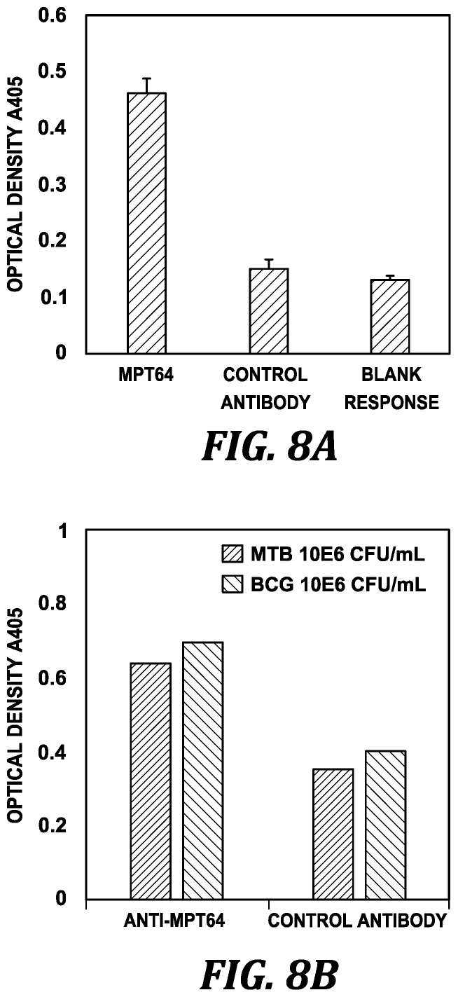

To assay for the MPT64 protein, 100 μL of a 100 μg/mL solution of MPT64 in DPBS was added to an ELISA 96-well plate (Immulon 2HB, Thermo Scientific #3455). The mixture was incubated overnight at room temperature, followed by 1-hour incubation at 37° C., and then washed with 3×200 μL DPBS. To block the remaining sites in the well, a 200 μL BSA solution in DPBS at 1 mg/mL was added and incubated for 1 hour at 37° C. followed by washing with 3×200 μL DPBS. A 100 μL solution of IgY (28 μg/mL in DPBS) raised against MPT64 was added to each well. Control (pre-immune IgY) antibodies were tested at the same concentration. A 100 μL solution of a 1:1000 dilution of secondary antibody (Rab anti-IgY-HRP Conjugate, Thermo Scientific #31401) was then added and incubated for 30 min at 37° C., followed by DPBS washing (3×200 μL). Finally, 100 μL of ABTS substrate was added and measured at A405 after 10 min incubation at room temperature. In comparison to pre-immune antibodies, the positive results were shown to MPT64 (FIG. 8A†).

To evaluate antibodies against Mycobacterium, the cultures of Mycobacterium Bacillus Calmette—Guérin (BCG) and MTB (H37Ra) cells were diluted to 1×10⁶ cells/mL in PBS, calculated by absorbance at OD₆₀₀, where the absorbance of 0.1 corresponded to a concentration of 6.3×10⁷ CFU/ml. The cell solutions (100 μL of MTB or BCG) were then added to a well in a 96-well filter bottom plate (Millipore 0.45 μM, #MAHVN4510). The cells were captured by filtration on the surface of the 0.45-micron filter and washed 3 times with 200 μL Dulbecco's Phosphate Buffered Saline (DPBS) with vacuum filtration. A 100 μL solution of IgY antibodies (28 μg/mL) was added to each well and incubated for 30 min at 37° C. Control (pre-immune IgY) antibodies were tested at the same concentration. The IgY solution was removed by vacuum filtration, and the filters were washed with 4×200 μL DPBS. A 100 μL solution of a secondary antibody (1:1000 dilution Rab anti-IgY-HRP Conjugate, Thermo Scientific #31401) was added to each well and incubated for 30 mM at 37° C., followed by washing with DPBS (3×200 μL). Finally, 100 μL 2,2′-azino-bis (3-ethylbenzothiazoline-6-sulphonic acid) (ABTS) substrate (Thermo Scientific #37615) was added, followed by a 10 mM incubation at room temperature. The solution was then filtered through the filter plate into a clear 96-well plate, which was read at A₄₀₅ in a microplate reader. According to the ELISA results, the polyclonal antibodies were specific to both Mycobacterium strains and non-tuberculosis Mycobacterium (NTM) species (FIG. 8B†).

Preparation of Magnetic Particles

Carboxyl-functionalized superparamagnetic particles (Ocean Nanotech #MHP-100-01) were functionalized with anti-MPT64 antibody using a protocol modified from the bead manufacturer. Briefly, a 600 μL aliquot of the 10 mg/mL stock magnetic particles (MPs) was removed from the storage solution by applying a magnet for 5 minutes followed by careful removal of the storage liquid with a pipette. The bead solution was then resuspended in a 0.5 mL solution of 0.4 M 1-ethyl-3-(3-dimethylaminepropyl) carbodiimide HCl (EDC) (Thermo Scientific #22980) and 0.1 M N-hydroxysulfosuccinimide (NHS) (Thermo Scientific #24510) in double-distilled (DDI) water and incubated for 15 minutes. The activated beads were then washed once by magnetic separation with 0.5 mL-DDI water (4° C.), resuspended in 0.3 mL of the antibody solution (17 mg/mL antibody in DPBS), and reacted for 3 hours with mixing at room temperature. The bead-antibody solution was then washed three more times by magnetic separation in a storage buffer supplied by the manufacturer (10 mM PBS buffer with 0.02% NaN₃, 0.01% Tween 20, and 0.1% BSA).

Sensor Characterization

For sensor functionalization, the antibody immobilization step followed by the curing step was critical to enhance a signal-to-noise ratio because the surface charge of SWCNTs was sensitively changed. During antibody immobilization, the sensor resistance increased due to the bindings of antibodies, hydrogen, and ions on SWCNTs. To study the antibody contribution to the resistance change, the antibody concentration varied from 0, 0.9, 1.8, and 4.5 mg/mL in PBS buffer. After 24 hours of incubation of a SWCNT sensor in each solution, the resistance was measured right after rinsing the sensor in DI water, which was compared to the resistance before the immobilization.

When the sensor was exposed to air from antibody solution, the sensor resistance started to decrease due to hydrogen desorption. The desorption process was critical to obtain a reproducible resistance measurement after target binding. The temperature to cure the SWCNT sensors in the desorption step turned out to control the doping effect and the signal-to-noise ratio. To study the resistance change due to the curing effect, PEI-coated SWCNT sensors were incubated in the antibody solution, PBS, and DI water. The incubated samples were cured at 25 and 35° C. for 5 hours.

To characterize how the sensor response changed due to hydrogen desorption, the sensor response to targets (MTB at 10⁶ CFU/mL in PBS) was tested after 5, 20, 40 and 120 minutes of curing at two temperatures, 25 and 35° C. The curing time of 5, 20, 40, and 120 minutes was determined in consideration of the slope change of the resistance.

Sensitivity and Specificity Tests

For sensitivity and specificity tests, both MTB and MPT64 were suspended in 1× PBS buffer. For MTB, various concentrations of MTB cells were suspended in PBS from 10¹˜10⁵ CFU/mL. MPT64 was also suspended in PBS from 0.1 ng/mL to 1 μμg/mL with 10-fold dilutions. 1 mL of each solution was supplied in each plastic cup where a sensor was immersed for immunocomplex formation. After 10 min of the incubation, the sensor was rinsed with DI water. After the gentle blow dry with nitrogen, the resistance was measured. The resistance values before and after immunocomplex formation were Ro and R_{f}, respectively. The normalized resistance change [(R_{f}−R₀)/R₀] was computed to compare the signal from the control.

For specificity tests, the response for MTB (10² CFU/mL) was compared with Staphylococcus Epidermidis (S. Epi at 10³ CFU/mL), Mycobacterium Avium (M. Avium at 10³ CFU/mL), and BCG at 10³ CFU/mL. The bacterial samples were suspended in 1 mL PBS.

Test using Tongue Swab Samples

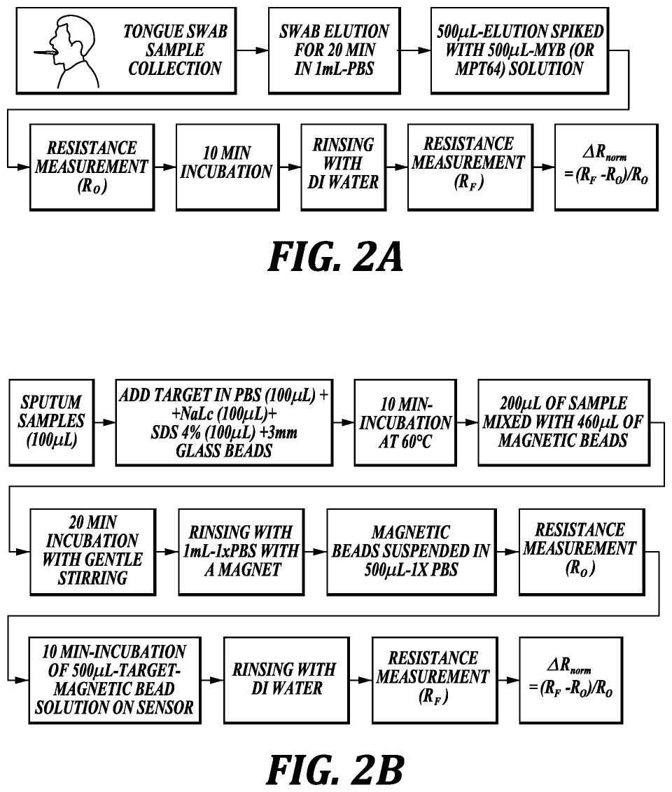

Tongue swab sampling is a newer approach for obtaining MTB markers of infection. To evaluate LLD for MTB and MPT-64 in tongue swab samples, the swab samples were prepared by scraping tongue surface from deidentified volunteers (FIG. 2A). After the complete drying of swabs in air, the swab samples were immersed in 1 mL PBS for 20 minutes with gentle stirring. Subsequently, 500 μL of the target analyte (MTB or MPT64) in PBS was mixed with 500 μL of the eluted swab solution. The 1 mL solution was used to test the LLD. The spiked concentrations of MTB ranged from 10 to 10⁵ CFU/mL in steps of 10-fold dilutions. The concentrations of MPT64 ranged from 1 ng/mL to 10 μg/mL with steps of 10-fold dilutions. For analysis, each sensor was incubated with a 1 mL sample solution for 10 minutes followed by the rinsing in DI water. Before and after target binding, the resistance was measured to compute a normalized resistance.

Test using Human Sputum Samples with Magnetic Nanoparticles

The test protocol for human sputum samples is described in FIG. 2B. Deidentified human sputum samples were obtained from BioReclamation, Inc. To reduce the viscosity and liquefy the sputum, 100 μL sputum was first mixed with 100 μL-PBS followed by 100 μL-NaLc (4 mg mL-1N-acetyl-L-cysteine). Also, 3 mm-glass beads and a 4% SDS solution (sodium dodecyl sulfate, 100 μL) were added to the mixture with the addition of the targets. The mixture was vortexed for 10 minutes with 60° C. heating for complete liquefaction.

For magnetic enrichment of MTB (100μL; 10˜10⁴ CFU/mL in 10-fold increments), 200 μL of the 400 μL-liquefied sputum samples were mixed with 10 μL of magnetic beads suspended in 450 μL PBS. After 20 minutes of gentle stirring and incubation, the magnetic beads were held with a magnet while the sample solution was gently aspirated. The magnetic beads were then washed with 1 mL PBS followed by magnetic separation. After rinsing, 500 μL of PBS solution was used to suspend the magnetic beads bound to the target. Using this protocol, the LLD was evaluated for MTB.

To evaluate LLD for MPT64, the protocol was slightly modified. Sputum samples (100 μL) were mixed with 100 μL-NaLc and 100 μL-4%-SDS. MPT64 (100 μL; 0.1˜10⁴ ng/mL in 10-fold increments) was spiked in the mixture. Without 60° C. heating to avoid protein damage, the dissipated sputum samples were mixed with the magnetic beads. The following procedure was the same as the MTB-sputum protocol.

Sensor Characterization

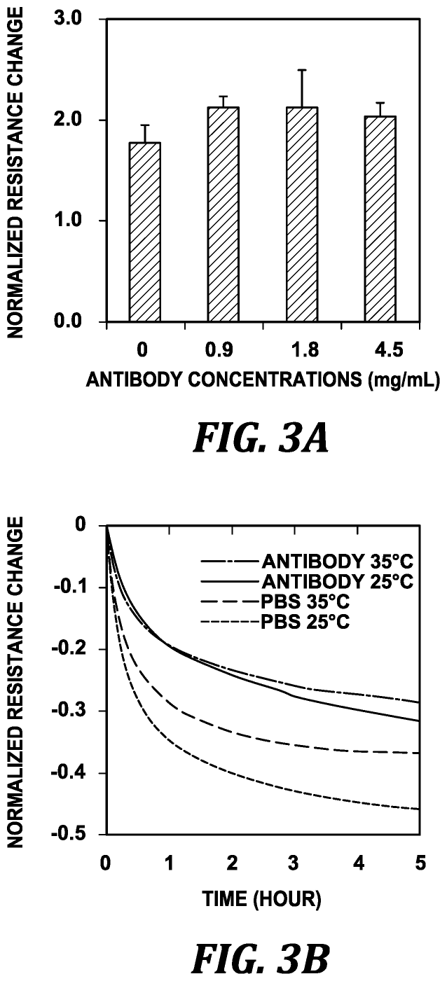

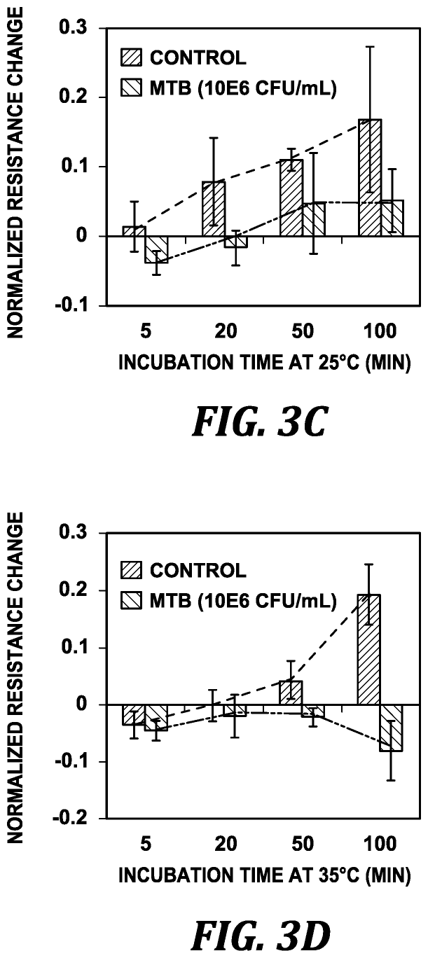

In the antibody immobilization step of 24 hours, the resistance of SWCNT sensors increased by the bindings of hydrogen, ions, and antibodies. Since the most ions in PBS were washed in the rinsing step after antibody immobilization binding, the effect of ions in PBS could be neglected. FIG. 3A shows the normalized resistance change of SWCNTs before and right after antibody immobilization for antibody concentrations of 0.9, 1.8, and 4.5 mg/mL. The normalized resistance change of SWCNTs in PBS was 1.78 while those in antibody solutions varied from 2.04 to 2.12 on average. Out of 108% resistance increase, 78% of the resistance change was contributed by hydrogen and ion bonding, and 30% was by antibody binding on average.

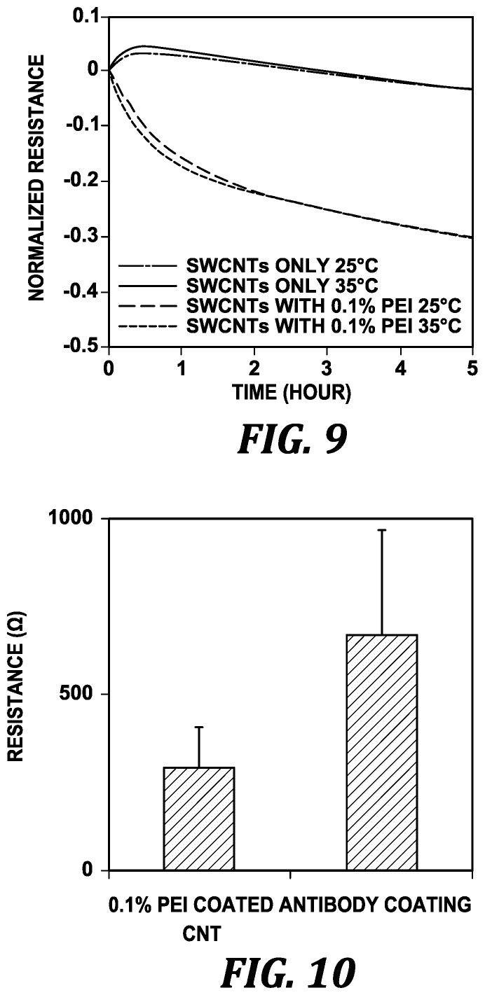

After the antibody immobilization, the sensor's resistance continuously decreased due to hydrogen desorption. To make the resistance stable, a sensor was cured at 25° C. and 35° C. for 5 hours. To study the resistance change due to the curing effect, the SWCNT sensors were incubated in the antibody solution, PBS, and DI water. As the curing time increased, the resistance decreased due to hydrogen desorption (FIG. 3B). Interestingly, the resistance change at 35° C. was smaller than 25° C. Without wishing to be bound by theory, the resistance change was also related to the oxidation of the PEI layer. With the greater oxidation of the amine group of the PEI layer at the higher temperature, the SWCNT resistance at 35° C. decreased less than that at 25° C. The sensors incubated in PBS showed the similar trend. When SWCNT sensors with and without a PEI layer were incubated in DI water for 24 hours and cured at the two temperatures for 5 hours, the sensor with a PEI layer showed similar response. Without a PEI layer showed bump followed by down slope (FIG. 9†). The bump of the resistance in the air exposure was caused by the counter doping effect of SWCNTs in water. The results implied that the PEI layer could be oxidized more at 35° C. than 25° C., which changed the doping level of SWCNTs and increased the sensitivity.

To study the sensor response for the curing effect at 25° C. and 35 ° C., the immunoassay was tested for MTB (10⁶ CFU/mL) in PBS. The curing times were 5, 20, 40, and 120 minutes. FIG. 3C shows the change of a normalized resistance at 25° C. As the curing time increased, the normalized resistance of the control samples increased less than that of MTB. However, the error bars were overlapped to differentiate the MTB signal from the control.

FIG. 3D shows the normalized resistance change for MTB (10⁶ CFU/mL) at 35° C. The control was negative at 5 min and gradually increased to a positive value. The normalized resistance of the positive MTB samples maintained slightly negative values and dropped to −0.08. When the control was compared with the positive cases, a signal could be detected for the samples of 40 min and 120 min incubation at 35° C. The resistance change before and after 120 min incubation at 35° C. was stable from 292 to 669 Ω after antibody coating (FIG. 10†). In a further experiment, the incubation time was maintained as 120 min for the reliable performance of the sensors.

Sensitivity and Specificity Tests

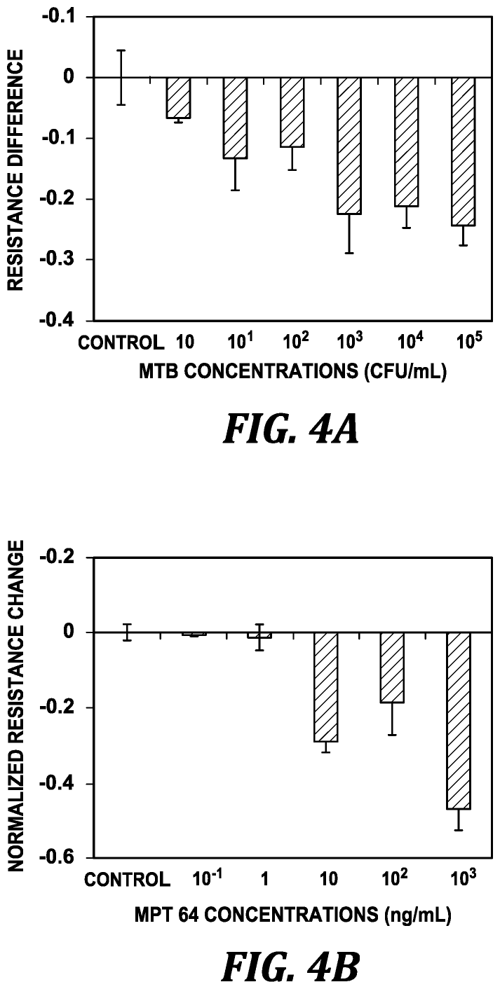

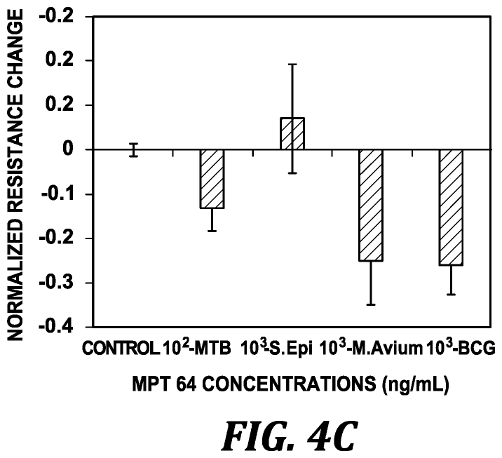

For sensitivity tests, various concentrations of MTB cells in PBS buffer were tested, as shown in FIG. 4A. The signal from 10 to 10⁵ CFU/mL was compared to the control. In these tests, the normalized resistance change for the control was measured between 0.15 and 0.25. The average value of the normalized resistance for the control was shifted to 0 for convenience of reporting. The control signal was shifted down, while the detection signal was even further decreased. Despite the high sensitivity, the resistance change was not quantitative with respect to MTB concentration. It was speculated that the qualitative signal was resulted from the nonuniform binding of target cells on the sensor surface. Considering the electrostatic interaction effective within 10 nm, the number of binding spots could determine the resistance change. When the dose-response test was conducted for antigen MPT64 (FIG. 4b), the signal was detectable starting at 10 ng/mL.

For the specificity test, the signal of MTB at 100 CFU/mL was clearly differentiated from the control and S. epi at 10³ CFU/mL (FIG. 4C). However, M. Avium (10³ CFU/mL) and BCG (10³ CFU/mL) showed a positive response due to the cross-reactivity to Mycobacterium strains, including NTM. The cross-reactivity to Mycobacterium strains corresponded with the results of the ELISA assay (FIG. 8B†).

Tests using Tongue Swab Samples

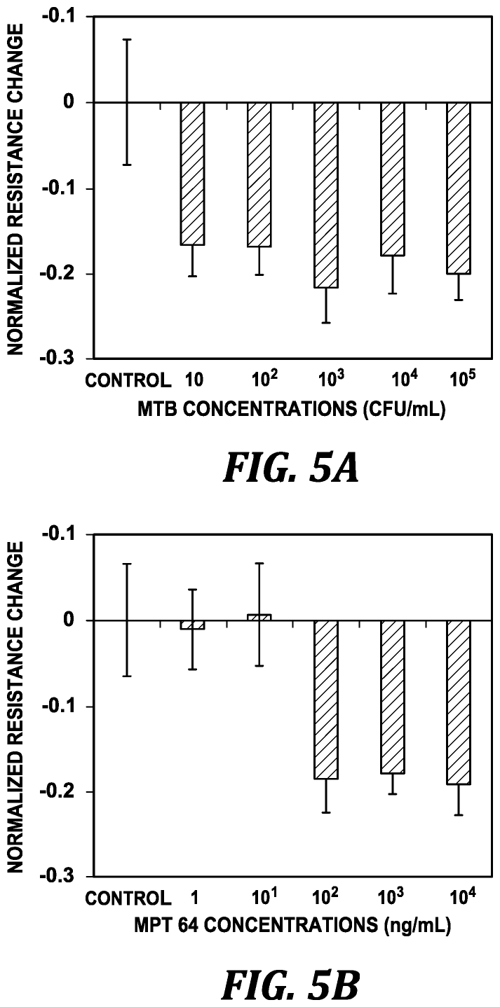

To evaluate the LLD for tongue swab samples, MTB at the concentrations ranging from 10 to 10⁵ CFU/mL were spiked into tongue swab samples. The detection limit was 10 CFU/mL (FIG. 5A). According to the dose-response test, the resistance change was not quantitative but qualitative.

For the detection limit test using MPT64 antigen, the LLD was 100 ng/mL, which was also qualitative (FIG. 5B). Given that tongue swab samples were replete with human cells, bacteria, and other microorganisms, these results also demonstrated the superior specificity of the SWCNT sensor.

Tests using Human Sputum Samples with Magnetic Beads

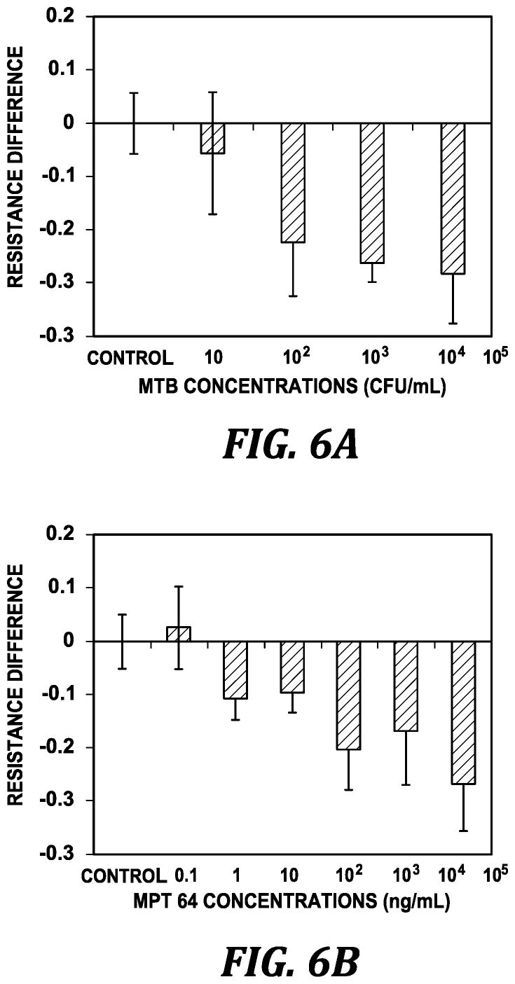

For detection in sputum samples, the targets were spiked in sputum samples. MTB cells of 10˜10⁴ CFU/mL were mixed with NaLc-treated sputum samples. MPT64 was spiked in the range of 0.1˜10⁴ ng/mL. With liquefaction process, the targets were enriched on magnetic beads. The collected beads were rinsed and detected by using SWCNT sensors. The detection limit was 10² CFU/mL (FIG. 6A) for MTB and 1 ng/mL for the MPT64 antigen (FIG. 6B). Without magnetic enrichment, the resistance of SWCNT sensors could not work owing to the reagents to liquefy sputum samples.

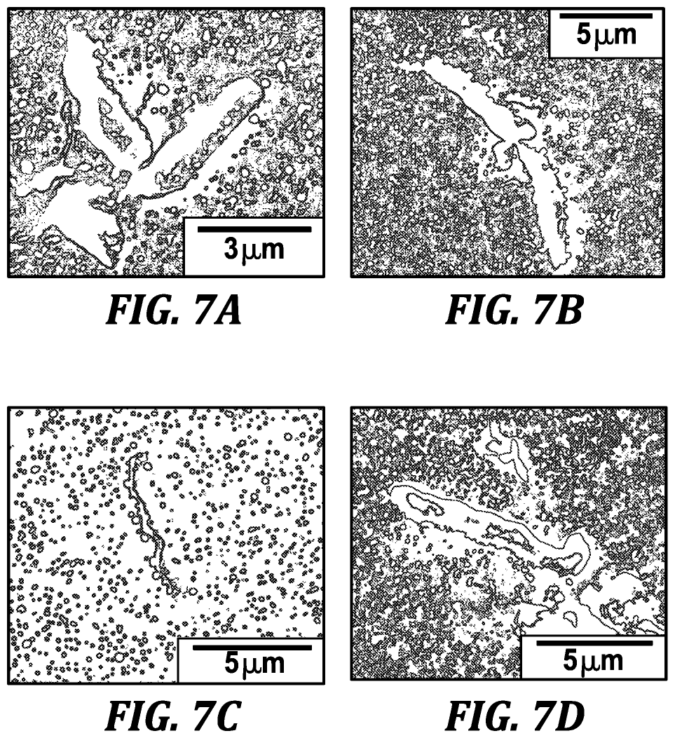

To validate if the target cells were captured on a sensor surface, MTB cells (10⁶ CFU/mL in PBS) were observed on the SWCNT surface (FIG. 7A and 7B). FIG. 7C and 7D show the SEM images of MTB cells (10⁶ CFU/mL in PBS) bound with magnetic beads on the SWCNT surface. In the images, the white dots appeared crystallized ions from PBS. Under the SEM images, magnetic nanoparticles could not be discerned from the crystal ions. The qualitative, not quantitative signal could be caused by the binding nature between bacterial cells and sensor surface. Considering the effective range of electrostatic detection as 10 nm, the nonuniform binding of target cells could result in a qualitative signal. The qualitative signal may also be related to the large gap size of 200 μm, explaining the saturation of the resistance change in the large gap size.

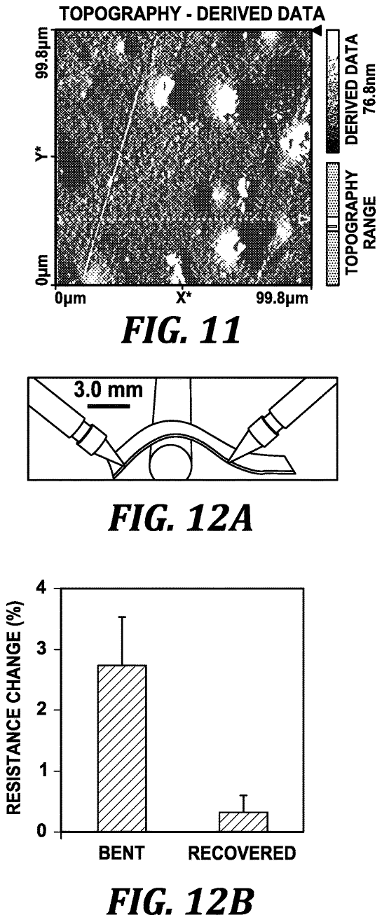

The use of PET films as sensor substrates can significantly reduce the material and manufacturing costs. Unlike the gold electrodes on silicon chips, the deposition of SWCNTs on silver electrodes resulted in unreliable contact resistance due to the oxidized silver layer. The rough surface of a PET film made the contact resistance higher. According to a study using an atomic force microscope, the roughness ranges from 15 to 80 nm with the bumps on the surface (FIG. 11†).

By stamping silver electrodes on a SWCNT film, a reliable resistance of a SWCNT sensor could be obtained. One of the major differences between silicon and PET substrates was the doping of SWCNTs on the PET film. While the SWCNTs on oxidized silicon chips were doped with hydroxyl groups, those on PET films were doped with carboxyl groups. Although both substrates made SWCNTs p-type, the doping on a rough PET film could significantly change the contact resistance of a SWCNT sensor in combination with the PEI layer. For stable performance, the delicate control of the functionalization layers was critical. In future, the addition of a control sensor next to a sensor will enhance the signal-to-noise ratio by compensating environmental factors including temperature.

The flexible PET film substrate can be attached or bent to fit a testing condition. The resistance change upon bending was tested (FIG. 12†). When the sensor was bent by a radius of 1.5 mm and recovered with the stress release, the resistance change was 0.33%. In comparison to the change of signal resistance >10% with specific measurements, the 0.33% resistance change can be neglected. The bending test results show that the sensor can be bent during target binding and operation. However, the measurements should be conducted without external stress. The flexible nature will benefit the sensor application in the platforms requiring a small form factor and low cost.

In summary, an exemplary immuno-resistive SWCNT sensor was developed to specifically detect Mycobacterium tuberculosis (MTB) cells and surface antigen (MPT64) spiked in tongue swab and sputum samples. The detection limits were 10 CFU/mL for MTB and 100 ng/mL of MPT64 in tongue swab samples with the detection time of 30 minutes. For sputum samples, magnetic enrichment of targets was combined with the SWCNT sensors. The LLD for MTB and MPT64 spiked in sputa were 100 CFU/mL and 1 ng/mL, respectively. The LLD was comparable to PCR but without requiring bacteriological culture, centrifugation, or nucleic acid amplification. To achieve such high sensitivity and specificity, the resistance change of a SWCNT sensor coupled with the fabrication and functionalization protocols was studied to determine the optimal curing temperature and time of 35° C. and 2 hours. Unlike other SWCNT-based sensors employing silicon chips, the presented sensor was fabricated on a flexible PET film, which provides a low cost and a lightweight platform. The simple resistive measurement can allow rapid screening by minimally trained personnel. Also, a minimal power requirement (<1 W) combined with low assay cost will be ideal for point-of-care (POC) screening in limited-resource settings.

While illustrative embodiments have been illustrated and described, it will be appreciated that various changes can be made therein without departing from the spirit and scope of the invention.

1. A sensor, comprising:
a substrate comprising an upper surface;
a carbon nanotube film bonded to the upper surface of the substrate, comprising carbon nanotubes and a polymeric coating;
one or more electrodes in contact with the carbon nanotube film, wherein the one or more electrodes are formed on top of a portion of the carbon nanotube film; and
one or more sensing moieties configured to recognize one or more target analytes, wherein the one or more sensing moieties are bonded to the carbon nanotube film.

2. The sensor of claim 1, wherein the substrate is a flexible substrate.

3. (canceled)

4. (canceled)

5. The sensor of claim 1, wherein the carbon nanotubes are selected from the group consisting of single walled carbon nanotubes, double walled carbon nanotubes, multi walled carbon nanotubes, or a combination thereof.

6. (canceled)

7. The sensor of claim 1, wherein the carbon nanotubes are treated to desorb pysisorbed hydrogen.

8. (canceled)

9. (canceled)

10. The sensor of claim 1, wherein the polymeric coating comprises a material comprising one or more functional moieties.

11-15. (canceled)

16. The sensor of claim 1, wherein the one or more sensing moieties are configured to capture one or more target analytes selected from the group consisting of a cell, microorganism, protein, peptide, nucleic acid, lipid, and small molecule.

17. The sensor of claim 1, wherein the one or more sensing moieties is an aptamer, an antibody, or a binding fragment thereof

18. The sensor of claim 1, wherein the one or more sensing moieties is an antibody against a viral surface antigen, a fungal surface antigen, a bacterial surface antigen, a membrane protein, or an immunoglobulin.

19-30. (canceled)

31. The sensor of claim 1, wherein the sensor is configured to detect the target analyte by an electrostatic gating effect and not a Schottky effect.

32. The sensor of claim 1, wherein the sensor is configured to detect the resistance change at the interface of the carbon nanotubes and one or more metal electrodes.

33. The sensor of claim 1, wherein the sensor is configured to measure the resistance or electric current generated upon binding of the target analyte to the one or more sensing moieties.

34. The sensor of claim 1, wherein the resistance change of carbon nanotubes is amplified by the means selected from a group consisting of charged molecules, electrochemical amplification, and magnetic force.

35. The sensor of claim 1, wherein the one or more electrodes have interdigitated, rectangular, or circular shapes.

36. The sensor of claim 1, wherein the sensor is flexible or bendable.

37. The sensor of claim 1, wherein the sensor is configured to monitor the presence of a target analyte in real time.

38. The sensor of claim 1, wherein the monitoring of the presence of a target analyte is performed in vivo, ex-vivo, or in vitro.

39. The sensor of claim 1, wherein the sensor is configured to be incorporated into a container, a wearable gear, a mask, glasses, an item of clothing, or an item of personal protective equipment (PPE).

40. A method of forming a sensor, comprising:
depositing carbon nanotube powder on a surface of a substrate to form a substrate comprising a layer of carbon nanotubes bonded to the surface of the substrate;
coating the layer of carbon nanotubes with a polymeric coating to form carbon nanotube film;
forming one or more electrodes in contact with the carbon nanotube film on a portion of the carbon nanotube film; and
contacting the portion of the carbon nanotube film not covered by the one or more electrodes with one or more sensing moieties configured to recognize one or more target analytes with the carbon nanotube film thereby binding the one or more sensing moieties to the carbon nanotube film.

41-58. (canceled)

59. A sensor formed by the method of claim 40.

60. A method of detecting one or more target analytes in a sample, comprising contacting a sample with a sensor of claim 1.

61-64. (canceled)
